(19) United States
(12) Patent Application Publication
(10) Pub. No.: US 2018/0239591 A1
(43) Pub. Date: Aug. 23, 2018

(54) PARALLEL GENERATORS OF RANDOM NUMBERS ON GEOMETRICAL STRUCTURES

(71) Applicants: Naoya NAKAZAWA, Osaka (JP); Hiroshi NAKAZAWA, Osaka (JP)

(72) Inventors: Naoya NAKAZAWA, Osaka (JP); Hiroshi NAKAZAWA, Osaka (JP)

(21) Appl. No.: 15/684,748

(22) Filed: Aug. 23, 2017

(30) Foreign Application Priority Data
Feb. 20, 2017 (JP) 2017-044355

(51) Int. Cl. G06F 7/58; G06F 17/12; G06F 17/15; G06F 17/18

(52) U.S. Cl. CPC G06F 7/588; G06F 17/12; G06F 2207/582; G06F 17/18; G06F 2101/14; G06F 17/153

(57) ABSTRACT

A method for realization of samples of random numbers distributed on temporal and spatial lattice points is described. The method may include using samples obtained by integrating a temporal and spatial white noise over the temporally smallest unit and over the spatial unit of volume, with the distribution of samples. The method may ensure small correlations to neighboring samples in temporal as well as spatial directions.

### CROSS-REFERENCE TO RELATED APPLICATION

This application claims priority under 35 U.S.C. § 119(a) to Japanese Patent Application No. 2017-044355, filed Feb. 20, 2017, which is incorporated by reference herein in its entirety.

### FIELD

The subject matter disclosed herein related generally to random number generators.

### BACKGROUND

Let S be a sequence of uniform random numbers with good local sequential independence. The present state of arts stipulates that a multiplicative congruential (MC) generator may realize closely such an ideal statistics by methods of selection by powerful spectral tests. However, difficulties remain in that distant random numbers on the sequence S may have uncontrolled, non-negligible correlations. There exist GFSR-type generators, typically Mersenne twister of Matsumoto and Nishimura (1998), which exploit primitive polynomials on finite fields and realize gigantic lengths of periods with the charming “equidistribution property” over their whole periods. However, equidistribution property does not ensure the local goodness of GFSR-type random number sequences and, above all, GFSR sequences lack means to “test” reliably on their local statistical goodness which is to be valid anywhere on their whole length of gigantic periods. The invention presented here is a new methods of spectral tests on the classic MC generators, but which is based on two new recently attained arts. Methods of spectral tests was first noticed of the suggestion for its wide range of possibilities by the work of Fishman and Moore (1986). The methods recently acquired new wider ways of applications and fundamental corrections in methods themselves. The former is the method of generalized 2nd degree tests by Nakazawa and Nakazawa (2014A), which give very stern results with very light computing burden. The latter is a completely new method to use the so-called regular L-simplex criteria for tests of degrees L with 3≤L≤6. These innovations enabled us to proceed over the difficulties recognized in so-called “combined generators” (Wang et al. (2011)) that spectral tests in prior arts could not find any passers and new invented ways of spectral tests give us now excellent MC generators with periods around and over T≈2⁵⁰, as posted in Nakazawa and Nakazawa (2014C); faster computers with larger scale allowing for quadruple precision arithmetic of integers will enable us to go over this magnitude of T. Despite these brilliant attainments of random number sequence with excellent local statistics, however, elements at positions far apart in S may have strong correlations. Please see the example in the behavior of the generalized 2nd degree spectral tests of the most excellent generator noted #3 therein, for results of 2nd degree tests of (d, z^{k}) for 1≤k≤100. The difficulty arises unavoidably with any excellent generators on computers. We now show, however, that there exist ways to evade the difficulty in MC generators. Spoken more explicitly, there are ways to construct geometrical arrays of spatial L-dimensional lattices, on which MC generators are distributed realizing the property that emitted random numbers at a lattice point has excellent time-sequential statistics while random numbers generated at neighboring lattice points have the property of excellent non-correlation with neighbors in directions to geometrical coordinate axes. This invention stands as a generalization of similar structures distributed on a spatial one-dimensional lattices discussed in Nakazawa and Nakazawa (2016 A, B).

### REFERENCES

(1) Fishman and Moore (1986)/G. S. Fishman and L. R. Moore: An exhaustive analysis of multiplicative congruential random number generators with modulus 2³¹−1, in SIAM Journal on Scientific and Statistical Computing 7 (1986), pp. 24-45.
(2) Matsumoto and Nishimura (1998)/M. Matsumoto and T. Nishimura: Mersenne twister: a 623-dimensionally equidistributed uniform pseudo-random number generator, in ACM Transactions on Modeling and Computer Simulation 4 (1998), pp. 3-30.
(3) Wang et al. (2011)/M. Wang et al.: Combined random number generators: a review, in IEEE 3rd International Conference on Communication Software and Networks (ICCSN), (2011), pp. 443-447
(4) Nakazawa and Nakazawa (2014A)/N. and H. Nakazawa: Constructive design of uniform and independent random number generators, uploaded on Apr. 29-Aug. 5, 2014 in the URL http://nakazawa-patents.jp/index2015.html with the filename invention1a.pdf.
(5) Nakazawa and Nakazawa (2014B)/N. and H. Nakazawa: Methods of spectral tests of multiplicative congruential random number generators, uploaded in the URL http://nakazawa-patents.jp/index2015html on Jun. 5-Jul. 30, 2014 with the filename invention2k.pdf.
(6) Nakazawa and Nakazawa (2014C)/H. and N. Nakazawa: The prospectus of Nakazawa Patents, uploaded on Jul. 12-Oct. 26, 2014 in the URL http://nakazawa-patents.jp/index2015.html with the filename eprospectus141026.pdf.
(7) Nakazawa and Nakazawa (2016A)/H. and N. Nakazawa: New spectral tests for parallel random number generators, uploaded on Aug. 24-Sep. 12, 2016 in the URL http://nakazawa-patents.jp/index2016prev.html with the filename parallelgeneratorb.pdf.
(8) Nakazawa and Nakazawa (2016B)/H. and N. Nakazawa: Parallel random number generators on geometrical structures, uploaded on Dec. 3, 2016 in the URL http://nakazawa-patents.jp/index.html with the filename parago16dec3.pdf.

### DETAILED DESCRIPTION

### Brief Summary

Necessary notations of MC random number generators are introduced. An MC generator comprises an integer d for the modulus, an integer z coprime to d as the multiplier and an integer s for the initial value or seed. They are summarized in a symbol (d, z, s), or (d, z) for short if the seed s is not relevant in arguments. The MC generator (d, z, s) generates the sequence of integers S: ={r₀, r₁, r₂, . . . } by recursive congruence relations

r₀:≡s(mod d), 0<r₀<d,

rⱼ:≡zrⱼ₋₁≡sz^{j-1}(mod d), 0<rⱼ<d, j≥1,

and gives the output sequence of uniform and independent random numbers

{vⱼ:=rⱼ/d|j=0,1,2, . . . }.

We regard the consecutive L outputs of integers (rⱼ, rⱼ₊₁, . . . , r_{j+L-1}) as the coordinates of the point Pⱼ or its position vector in the L-dimensional Euclidean space E_{L}. Points {P₀, P₁, P₂, . . . } are known to be on lattice points of an integer lattice, and this fact was exploited for the valuation of the performance of (d, z) generator, ever since the epoch making work of Fishman and Moore (1986) under the name of spectral tests. We use here the so-called generalized 2nd degree tests of Nakazawa and Nakazawa (2014A), and demand the generator (d, z^{k}) to pass criteria

1<μ_{d}⁽²⁾(z^{k})<1.25,k=1,2, . . . ,6.

Here, criteria take consecutive 2-tuples of integer outputs from the MC generator (d, z^{k}) as points on 2-dimensional lattices, considers largest distances {λ_{d}⁽²⁾(z^{k})|1≤k≤6} of said lattices between their adjacent parallel lattice lines, and compute

μ_{d}⁽²⁾(z^{k}):=λ_{d}⁽²⁾(z^{k})/{(d/2)^{1/2}3^{1/4}},k=1,2, . . . ,6.

Likewise, consecutive L-tuples of integer outputs from the generator (d, z) is tested by the L-th degree spectral tests of Nakazawa and Nakazawa (2014B) with the so-named regular L-simplex criterion. This implies that said L-tuple of integers are regarded as point in the L-dimensional space and to form an L-dimensional lattice with its largest distance λ_{d}^{(L)}(z) should give the following performance

1<μ_{d}^{(L)}(z)<1.25, 3≤L≤6,

μ_{d}^{(L)}(z):=λ_{d}^{(L)}(z)/{L^{-1/2}(L+1)^{(L-1)/(2L)}d^{(L-1)/L}}.

The premise for the present invention is the existence of an MC random number sequence S with its generator (d, z) fulfilling these two criteria; this is realized in 9 excellent generators posted in Nakazawa and Nakazawa (2014C). The invention aims to distribute such generators with suitable seeds on the geometrical lattice in the L-dimensional space so as to realize excellent non-correlation in time and to geometrical neighbors in the lattice.

We first describe the basic principle to be respected in the use of noted type of excellent MC generator and its output sequences of integers as well as of output random numbers. The first of the principle is that a simulation must use one and only one excellent MC generator and its output sequence. This is based on the technological reality met in finding excellent MC generators with the modulus d comprising 2 coprime factors d=d₁d₂. Suppose we choose excellent subgenerators (d₁, z₁) and (d₂, z₂) by spectral tests. This is a possible and almost exclusive way to evade the notorious computing-time difficulties of spectral tests for large modulus d. Yet, the probability that we obtain an excellent combined generator by Sun Tzu's theorem,

d=d₁d₂,z:≡zₖ(mod dₖ),k=1,2,

is extremely small. We should not expect without tests, therefore, that excellent subgenerators (d₁, z₁) and (d₂, z₂) will give an excellent combination. Additionally, large scale simulations of today need parallel computing without exception. The above stated circumstances demand us to use a single MC generator with long enough period T, and we should use its random number sequence S without any duplication. The sole possibility is to divide the sequence S into consecutive subsequences. We call such small subsequences as threads, and denote their unanimous length as M. This length M should be the smallest but sufficient number of steps needed in simulations. Our aim is thus how to define the length M and how to distribute MC subgenerators giving length-M threads on a geometrical lattices.

### DESCRIPTION OF EMBODIMENTS OF THE INVENTION

As the simplest and the most useful geometrical structures, we consider the N-dimensional Euclidean space E_{N} and its N-dimensional integer lattice L_{N} in the parallelepiped M₁×M₂× . . . ×M_{N},

L_{N};={(x₁,x₂, . . . ,x_{N})|xₖ is an integer, 0≤xₖ≤Mₖ−1, k=1,2,-,N}.

The aim is to distribute MC random number generators on lattice points of L_{N}, so as for them to work in parallel giving random number threads at each lattice point. Namely, we plant threads of random numbers at every lattice points and let them extend along the 0th axis for the time t. We may also say that the aim is to plant threads forming an (N+1)-dimensional lattice and realize the distribution of random numbers on this (N+1)-dimensional lattice points which have as little correlations as possible to 0th, 1st, 2nd, . . . , Nth neighbors. This may figuratively be said to realize an (N+1)-dimensional white noise on computers. Note that if random numbers on S are ideally uniform and independent, any way of distribution of generated random numbers may be used to the end. However, this is not tenable in reality. Our aim is to seek technologically for the way to imitate the noted ideal distribution within the limited excellence of MC random number generators.

The total number of lattice points L_{N} in the space E_{N} is Ω:=M₁M₂ . . . M_{N}. We put threads of length M on these lattice points. Hence we need the total number MΩ=MM₁M₂ . . . M_{N} of random numbers, and the planting of threads requires the period T≥MΩ=MM₁M₂ . . . M_{N}. We premise hereafter that this restriction on the period T is satisfied. The sole practical way to avoid duplicated use of random numbers is to divide the sequence S of random numbers into Ω consecutive threads {θ₀, θ₁, . . . , θ_{Ω-1}} of a unanimous length M. We regard these threads as (row) vectors along the 0th axis or the t-axis in the (N+1)-dimensional Euclidean space E_{N+1}, and denote them explicitly as follows:

{θₖ:≡sζ^{k}(1,z,z², . . . ,z^{M-1})(mod d)|k=0,1,2, . . . ,Ω−1}, ζ:≡z^{M}(mod d).

An arbitrary thread Ok is thus the sequence generated by MC generator (d, z, sζ^{k}). We may realize the planting or the distribution of all of these threads on the integer lattice L_{N} by just putting these seeds {sζ^{k}|(mod d)|k=0, 1, 2, . . . , Ω−1}. The problem is how to distribute them.

We think on the computer program that will realize the noted distribution, without annoying ourselves with the complexity of high dimensional spaces. In order to cope with the convention of programming that does not admit suffixes, we first prepare notations. We use the classic notation of programming to use capital letters such as

D:=d, Z:=z, S:=s.

We introduce the convention

M1:=M₁, M2:=M₂, . . . , MN:=M_{N}.

Lattice points of L_{N} cannot help being expressed by variables

I1:=I₁,I2:=I₂, . . . ,IN:=I_{N}, 0≤IK≤Mₖ−1, k=1,2, . . . ,N;

in particular, I_{N-1} cannot be expressed in this way, and please understand that we avoid its use. With these notations the distribution of seeds on the integer lattice LN may be denoted as the ARRAY(I1, I2, . . . , IN). The computing of ARRAY(I1, I2, . . . , IN) may be realized by the following FORTRAN subprogram, which shows in somewhat simplified form the computing flow of the program posted in Claim.

```
    SUBROUTINE SETTER(D, Z, S, M1, M2, ...,MN)
    INTEGER*8 A-Z
    COMMON ARRAY(0: M1 − 1, 0: M2 − 1, ..., 0: MN − 1)
    SEED = S
    COUNT = 0
    DO 10 IN = 0, MN − 1
        ................................................
    DO 10 I2 = 0, M2 − 1
    DO 10 I1 = 0, M1 − 1
    ARRAY(I1, I2, ...,IN) = SEED
    COUNT = COUNT + 1
10 CONTINUE
    WRITE(6, ‘ I20’ ) COUNT
    RETURN
    END
```

The integer variable COUNT is for the confirmation that the computing time amounts to Ω=M1*M2* . . . *MN. This program shows that starting seeds SEED:=ARRAY(I1, I2, . . . , IN) have the following neighboring relations:
(1) The transition I1→I1+1 is realized by the multiplication of SEED by ζ=ZETA≡ẑM (mod d).
(2) The transition I2→I2+1 is realized by the multiplication of SEED by ζ₁:≡ζ̂(M₁)≡ẑ(MM₁) (mod d).
(3) The transition I3→I3+1 is realized by the multiplication of SEED by ζ₂:≡ζ₁̂(M₂)≡ẑ(MM₁M₂) (mod d).
   . . .
(N) The transition IN→IN+1 is realized by the multiplication of SEED by ζ_{N-1}:≡ζ_{N-2} ̂(M_{N-1})≡ẑ(MM₁M₂ . . . M_{N-1}) (mod d).

We resume the ordinary notation, departing from the programming Seeds on the geometrical lattice L_{N} in the space E_{N} generally have the form s(z^{M})^{k}=sζ^{k} (mod d) with 0≤k≤M₁M₂ . . . M_{N-1}. Threads starting from them may be denoted explicitly as

θₖ:≡sζ^{k}(1,z,z², . . . ,z^{M-1})(mod d).

When we distribute seeds on the lattice L_{N} by the noted program, the whole of the (N+1)-dimensional array of generated random numbers (which we denote as V_{N+1}) has an element that moves to its neighbors by following multiplications modulo d,

(to t-axis or the 0th axis) multiplication by z modulo d;

(to x₁-axis) the multiplication by ζ:≡z^{M} (mod d);

(to x₂-axis) the multiplication by ζ₁:≡ζẑM₁≡ẑ(MM₁) (mod d);
. . .

(to x_{N}-axis) the multiplication by ζ_{N-1}:≡ẑ(MM₁M₂ . . . M_{N-1}) (mod d).

As above, let V_{N+1} denote the geometrical array of random numbers be constructed on L_{N} in the way described so far. Our aim is to make all random numbers are ensured to have little correlation in transitions to above shown neighbors. Clearly, the aim is realized by the following set of spectral tests:

(test 0, to t-axis or the 0th axis) spectral tests on the generator (d,z);

(test 1, to x₁-axis) spectral tests on the generator (d, ζ);

(test 2, to x₂-axis) spectral tests on the generator (d, ζ₁);
. . .

(test N, to x_{N}-axis) spectral tests on the generator (d, ζ_{N-1}).

We premised that (d, z) is excellent in test 0. Therefore, the excellence of all threads to the t-axis direction is ensured, up to 6th neighbors. We describe test 1 to test N separately. Cumbersome inferences to (mod d) will be abbreviated.
(Test 1) The transition in V_{N+1} to neighbors along the x₁-axis is effected by the MC generator (d, ζ≡z^{M}). We need to tune (d, ζ) to be excellent. This is effected by replacing M with M′=M, M+1, M+2, . . . step by step with ζ′=ẑ(M′), performing the generalized 2nd degree spectral tests of (d, (ζ′)^{k}) for k=1, 2, . . . , 6, say, within the criterions

1<μ_{d}⁽²⁾((ζ′)^{k})<1.25, 1≤k≤6.

Then we perform regular-simplex-criterion spectral tests of (d, ζ′) from 3rd up to 4th, 5th or 6th degrees so as to realize

1<μ_{d}^{(L)}(ζ′)<1.25, L=3,4, . . . .

Though the degree L up to 6 is ideal and desirable, the matter depends on many circumstantial elements, such as the available computing time. The multiplier z in the original MC generator (d, z) is the very rare existence under the modulus d chosen up to the 6th degree spectral tests. Thus, we may well have to be content asking (d, ζ′) to pass spectral tests only up to the 5th degree. Or, we might well have to loosen the criterion to 1<μ_{d}^{(L)}<1.30 or so. The compromise will be necessary according to the amount of our computing time, or of our computing budget. When an admissible valuation is obtained with (d, ζ′≡ẑ(M′)), we replace M by M′.
(Test 2) The transition to neighbors along the x₂-axis is effected now by the MC generator (d, ζ₁′) with ζ₁′=ẑ(M′M₁). To make the multiplier ẑ(M′M₁) excellent we tune the width M₁: We replace M₁ with M₁′=M₁, M₁₊₁, . . . , perform generalized 2nd degree tests of (d, (ζ₁″)^{k}=ẑz(kM′M₁′) for 1≤k≤6 say, and throw (d, ζ₁″) into the regular-simplex Lth degree spectral tests for degrees L=3, 4, . . . , and select an excellent (M₁)′.
. . .
(Test N) The final step of tuning takes the multiplier ζ_{N-1}′:≡ẑ(M′M₁′ . . . M_{N-1}′), increases M_{N-1}′ as M_{N-1}, M_{N-1}+1, . . . , so as to find an excellent M_{N-1}′ for which ζ_{N-1}′:≡ẑ(M′M₂′ . . . M_{N-1}′) is excellent in generalized 2nd degree spectral tests of (d, (ζ_{N-1}′)^{k}) for 1≤k≤6 and 3rd up to 5th (say) degrees of regular simplex spectral tests of (d, ζ_{N-1}′). Tuning steps end up with noted M′, M₁′, M₂′, . . . , M_{N-1}′ with unchanged M_{N}. We should again remind ourselves that the inequality for the total number of used random numbers

M′M₁′M₂′ . . . M_{N-1}′M_{N}′≤T, M_{N}′:=M_{N}

must hold true for the construction of parallel generators to be possible at all. In practices this restriction is experienced non-restrictive. In terms of threads to be distributed on the lattice G_{N}), the total number of threads is

Ω′:≡M₁′M₂′ . . . M_{N-1}′M_{N}′≤T/M′.

This configuration of threads is realized by distributing seeds

{ARRAY(I₁,I₂, . . . ,I_{N})|Iₖ=0,1, . . . ,Mₖ′−1, 1≤k≤N}

on G_{N}′, where we may instead take the subset G_{N} as said. But this operation might be dangerous in these intricate relations. By this reason claim 1 is stated without such streamlining in the present specification.

### SUMMARY

By taking a sequence S of MC random numbers with excellent statistics of uniformity and independence as generated from a (d, z, s) generator, and by exploiting the generalized 2nd degree spectral tests of (d, z^{k}) for 1≤k≤6 as well as L-th degree spectral tests under the regular L-simplex criterion for L≥3, the invention presents a method to divides S into consecutive threads of length M′, plants threads on lattice points of a lattice G_{N}′ in the N-dimensional Euclidean space with 1st, 2nd, . . . , Nth coordinate axes, and constructs in total an (L+1)-dimensional distribution of random numbers including the 0th time axis, in such a way that each random numbers are ensured to have little correlation with neighbors in 0th, 1st, 2nd, . . . , Nth axis directions.

### Problem

The presented invention aims to realize an excellent set of MC random numbers distributed on a lattice with bounded but large extension in space-time, showing little correlations to respective neighbors to temporal as well as geometrical directions, thus ensuring high-quality parallel simulations on computers for particles distributed on geometrical set and under the effect of external, non-correlated forces.

### Solution

Prepare an excellent MC random number sequence S with a sufficiently long period T, divide S into consecutive threads of length M. With generalized 2nd degree spectral tests up to the 6th power of the multiplier as well as with spectral tests of the generator for degrees greater 3, tune the length M along the time axis, also tune respective lengths along spatial and ensure little correlations to neighbors in temporal as well in spatial directions by suitably realizing the planting of the root of threads to spatial lattice points, and realize a set of random number threads on geometrical structures which may be generated in parallel.

### Effects of the Invention

The aimed ideal result is the realization of samples of random numbers distributed on temporal and spatial lattice points, with samples obtained by integrating a temporal and spatial white noise over the temporally smallest unit and over the spatial unit of volume, with the distribution of samples so realized as to ensure small correlations to neighboring samples in temporal as well as spatial directions. The present invention has shown the method to realize said ideal distribution of MC threads of random number samples which allows for their spatially parallel generation on computers. If the temporal development is not needed, as in random initial value problems of degrees of freedom distributed on spatial lattice points, the time axis may be re-interpreted as a spatial axis and the spatial dimension N in Claim may be taken as N−1 to recover the total dimension N. The Invention is thus amenable to generalizations and specializations to various random number problems on geometrical structures. A point to be noted, however, is that even the presented simplest construction may be totally very difficult, starting from the excellent random number sequence S, construction of spectral test programs for tuning, and probably long computing time to find good tuned results, will be a highly intricate and difficult procedures for usual researchers using simulations, programmers for computing games, not to say usual consumers who would need random numbers on their computers or portable phones. Their realization and equipment on computers will require the skill of professional computer engineers. and the use should be enabled as software archived in function libraries in computing centers or installed in programming languages, or as services in operating systems for computers or portable phones. The present Invention is believed to enable these innovative applications.

### Prospects

Said possibilities in applications fundamentally call for excellent MC random number generators with still larger period T. The prospects call for the general use of computers equipped with quadruple precision integer arithmetic beyond the present double precision machines. It is wished that universities, computer centers and their engineers, who are at present the sole people with accesses to such large scale computers, are heartily solicited to find excellent MC random number sequences with periods T≈2⁶⁰; their existence will facilitate greatly the standardization of invented generators on geometrical structures and greatly benefit researchers and general consumers in the world.

What is claimed is:

1. A method to realize a set of multiplicative congruential (MC) random numbers on geometrical lattice structures in such a way as to ensure little correlations among random numbers with neighboring coordinates, comprising:
the method first prepares an integer lattice G_{N}
G_{N}:={(I₁,I₂, . . . ,I_{N})|Iₖ is an integer, 0≤Iₖ≤Mₖ−1, 1≤k≤N},
in the rectangular parallelepiped M₁×M₂× . . . ×M_{N} for integers {Mₖ≥1|1≤k≤N} in the N-dimensional Euclidean space E_{N} with N≥1,
the method takes a MC generator (d, z, s) for uniform and independent random numbers constituted by the integer modulus d, the integer multiplier z coprime to d and the integer seed (or the starting value) s coprime to d, the generator (d, z, s) emitting an excellent sequence S of random numbers of period T, the excellence of S being in the sense that MC generators (d, z^{k}) for exponents from k=1 to k=6 show valuations 1<μ_{d}⁽²⁾(z^{k})<1.25 in (generalized) 2nd degree spectral tests and that (d, z) shows valuations 1<μ_{d}^{(L)}(z)<1.25 in L-th degree spectral tests with regular-simplex criteria for degrees L=3 up to (at least) L=4 or 5, and the method that then divides S into Ω consecutive threads of a unanimous length M with Ω≥M₁×M₂× . . . ×M_{N} and MΩ<T,
and the method tunes integers M, M₁, M₂, . . . , M_{N-1} to their appropriate values by consecutive steps (1) to (N) of spectral tests noted below;
(1) the first step tunes the length of threads by increasing M to M′:=M+1, M+2, . . . until the procedure realizes that
ζ′:≡ẑM′(mod d)
gives (d, (ζ′)^{k}) passing the (generalized) 2nd degree spectral test with the valuation in the range 1<μ_{d}⁽²⁾((ζ′)^{k})<1.25 for 1≤k≤6, and gives (d, ζ′) passing the degree L spectral test for regular L-simplex criterion starting from L=3 up to L=4, desirably up to L=5 or 6 within the valuation 1<μ_{d}^{(L)}(ζ′)<1.25;
(2) the 2nd step tunes the width M₁ of the rectangular parallelepiped by increasing it to M₁′:=M₁+1, M₁+2, . . . until it realizes that
ζ₁′:≡ẑ(M′M₁′)(mod d)
gives (d, (ζ₁′)^{k}) passing the (generalized) 2nd degree spectral test with the valuation in the range 1<μ_{d}⁽²⁾((ζ₁′)^{k})<1.25 for 1≤k≤6, and gives (d, ζ₁′) passing the degree L spectral test for regular L-simplex criterion starting from L=3 up to L=4, desirably up to L=5 or 6 within the valuation 1<μ_{d}^{(L)}(ζ₁′)<1.25;
(3) the 3rd step tunes the width M₂ of the rectangular parallelepiped by increasing it to M₂′:=M₂+1, M₂+2, . . . until it realizes that
(ζ₂)′:≡ẑ(M′M₁′M₂′)(mod d)
gives (d, (ζ₂′)^{k}) passing the (generalized) 2nd degree spectral test with the valuation in the range 1<μ_{d}⁽²⁾((ζ₂′)^{k})<1.25 for 1≤k≤6, and gives (d, ζ₂′) passes the degree L spectral test for regular L-simplex criterion starting from L=3 up to L=4, desirably up to L=5 or 6 within the valuation 1<μ_{d}^{(L)}(ζ₂′)<1.25;
. . .
(N) the N-th step tunes the width M_{N-1} of the rectangular parallelepiped by increasing it to M_{N-1}′: =M_{N-1}+1, M_{N-1}+2, . . . until it realize that
ζ_{N-1}′:≡ẑ(M′M₁′M₂′ . . . M_{N-1}′)(mod d)
gives (d, (ζ_{N-1}′)^{k}) passing the (generalized) 2nd degree spectral test giving the valuation in the range 1<μ_{d}⁽²⁾((ζ_{N-1})′}^{k})<1.25 for 1≤k≤6, and gives (d, ζ_{N-1}′) passing the degree L spectral test for regular L-simplex criterion starting from L=3 up to L=4, desirably up to L=5 or 6 within the valuation 1<μ_{d}^{(L)}(ζ_{N-1}′)<1.25;
and in the case that all tunings noted above fulfill T≥M′M₁′M₂′ . . . M_{N-1}′M_{N} the method finally defines the expanded integer lattice G_{N}′
G_{N}′:≡{(I₁,I₂, . . . ,I_{N})|0≤Iₖ≤Mₖ′−1,k=1,2, . . . ,N−1,0≤I_{N}≤M_{N}−1},
and defines an array of seeds ARRAY(I₁, I₂, . . . , I_{N}) on G_{N}′ and let the set of threads of (d, z) random numbers start on these seeds, the distribution of seeds being realized in the way to obtain small correlation between random numbers generated at geometrical neighbors, the distribution being described by simple operations in FORTRAN subprogram shown below with notations MPK for Mk′,
```
    SBROUTINE SEEDER(D, Z, S, MP, MP1, MP2, MP3, ..., MN)
    INTEGER*8 A-Z
      COMMON ARRAY(0:MP1−1, 0:MP2−1, ..., 0:MN−1)
      COUNT = 0
      SEED = 1
      CALL POWER(ZETA, D, Z, MP)
! POWER is a subroutine to compute ZETA = MOD(Z**MP, D)
  ! with 1 ≤ZETA < D for the index MP that can be very large
      DO 10 IN = 0, MN − 1
      .........................................................
      DO 10 I3 = 0, MP3 − 1
      DO 10 I2 = 0, MP2 − 1
      DO 10 I1 = 0, MP1 − 1
      ARRAY(I1, I2, I3, ..., IN) = SEED
      SEED = MOD(SEED*ZETA, D)
! this SEED may be computed within INTEGER*8 arithmetic
! by Sun Tzu's theorem if D = D1*D2 is a product of coprime factors
    COUNT=COUNT+1
    10 CONTINUE
      WRITE(6, ‘I20’) COUNT
    RETURN
    END
```
wherein COUNT is the flag to confirm that all seeds are distributed; from {M′, M_1′, M_2′, . . . M_N} thus constructed and reserved in the binary expansion or in more effective form, the simulation starts by preparing first to generate ARRAY from them, or the simulation starts by reading the data of ARRAY from HD, SSD, USB into the main memory, or the simulation starts by utilizing the ARRAY equipped in some standardized form in the function libraries of computer centers, or the simulation or the game starts utilizing the ARRAY installed in some standardized form in operating systems as one of their services on computers or in portable phones.
